(19) United States
(12) Patent Application Publication
(10) Pub. No.: US 2021/0095143 A1
(43) Pub. Date: Apr. 1, 2021

(54) GRAVURE PRINTING OF NANOWIRES FOR LARGE-AREA PRINTED ELECTRONICS

(71) Applicant: North Carolina State University, Raleigh, NC (US)

(72) Inventors: Yong Zhu, Raleigh, NC (US); Qijin Huang, Raleigh, NC (US)

(21) Appl. No.: 17/038,502

(22) Filed: Sep. 30, 2020

Related U.S. Application Data
(60) Provisional application No. 62/908,708, filed on Oct. 1, 2019.

(51) Int. Cl. C09D 11/107; C09D 11/037; C09D 11/033; B41M 1/10; C08K 3/08; C08K 7/06

(52) U.S. Cl. CPC C09D 11/107; C09D 11/037; C09D 11/033; B82Y 30/00; C08K 3/08; C08K 7/06; B41M 1/10

(57) ABSTRACT

An ink composition includes a plurality of metal nanowires, one or more water soluble polymers, and an aqueous liquid carrier. Methods of gravure printing a metal nanowire structure onto a substrate are also disclosed, whereby the method includes depositing a first quantity of an ink composition into one or more cavities in a gravure plate, transferring the ink composition from the one or more cavities onto a substrate, and removing at least a portion of the liquid carrier and at least a portion of the one or more water soluble polymers from the ink composition to form a metal nanowire structure comprising a plurality of metal nanowires disposed on the substrate. The disclosed ink compositions and methods enable printing of high resolution, highly conductive metal nanowire structures.

### RELATED APPLICATION

This application claims the benefit of U.S. Provisional Application Ser. No. 62/908,708, filed Oct. 1, 2019, which is incorporated herein by reference in its entirety.

### STATEMENT REGARDING FEDERALLY SPONSORED RESEARCH

This invention was made with U.S. Government support under grant number 1160483, awarded by the National Science Foundation. The U.S. government has certain rights in the invention.

### TECHNICAL FIELD

The present disclosure generally relates to methods and compositions for gravure printing.

### BACKGROUND

Printed electronics has drawn tremendous interest in the past few decades (Refs. 1-6), as it offers an attractive alternative to conventional silicon-based fabrication technologies by enabling low-cost, large-area, flexible devices for many applications such as energy storage (Ref. 7), thin film transistor (Ref. 8), light-emitting diodes (Ref. 9) and wearable sensors for health monitoring (Ref. 10). Central to this technology are high-performance functional inks and high-throughput printing methods, such as screen (Ref. 11-15), inkjet (Ref. 16-18), gravure (Ref. 19, 20) and flexographic printing (Ref. 21). Among the existing printing methods, gravure printing, which utilizes direct transfer of functional inks through physical contact of engraved structures with a substrate, is a promising option for large-scale applications due to its high-speed, high-resolution deposition of functional materials and compatibility with roll-to-roll processes.

One important application of gravure printing is the fabrication of conductive elements as electrodes and conductors. The scope of gravure-printed electronic materials has been previously limited to polymers (e.g. PEDOT:PSS) (Ref. 22) and nanoparticles (Ref. 23, 24). Recently, one-dimensional nanomaterials (e.g. metal nanowires (Ref. 25, 26) and carbon nanotubes (Ref. 27, 28)) and two-dimensional nanomaterials (e.g. graphene) (Ref. 29, 30) have been gravure-printed on flexible substrates as flexible and transparent electrodes and interconnects. Among these nanomaterials, silver nanowires (AgNWs) have emerged with promising potential in electronic applications (Ref. 31-43). Compared to the silver particles used in the traditional silver inks, AgNWs offer better electrical conductivity and flexibility, which are key to flexible electronics applications. There have been recent studies on gravure printing of AgNWs as transparent conductive films (Ref. 25, 26), However, the best reported resolution was limited to 230 μm (Ref. 25). The printing resolution of gravure printing is mainly dependent on ink properties (e.g. surface tension and viscosity) (Ref. 44) in addition to trench resolution (Ref. 24). It remains challenging to realize high-resolution gravure printing of AgNWs as a result of their large length-to-diameter aspect ratio.

### SUMMARY

In one aspect, the present disclosure provides an ink composition including a plurality of metal nanowires, one or more water soluble polymers, and an aqueous liquid carrier. In one embodiment, the plurality of metal nanowires includes silver nanowires.

In another aspect, the present disclosure provides a method of gravure printing a metal nanowire structure onto a substrate including the steps of depositing a first quantity of the ink composition described herein into one or more cavities in a gravure plate; transferring the ink composition from the one or more cavities onto a substrate; and removing at least a portion of the liquid carrier and at least a portion of the one or more water soluble polymers from the ink composition to form a metal nanowire structure comprising a plurality of metal nanowires disposed on the substrate.

### BRIEF DESCRIPTION OF THE DRAWINGS

The present disclosure may be better understood with reference to the following figures.

FIG. 1A shows fabrication process of AgNW ink and photograph of the 5 wt % AgNW ink. FIG. 1B shows viscosity as a function of shear rate for different concentration of AgNW inks.

FIGS. 2A-2D show schematic illusion of the inverse direct gravure printing process.

FIG. 3A shows photograph of a printed AgNW line with length of 3 cm and width of 50 μm. FIG. 3B shows optical image of three AgNW lines with different line widths (50, 125 and 150 μm) and the same spacing of 100 μm. FIG. 3C shows morphology of the printed AgNW line. FIGS. 3D and 3E show histograms and polar diagrams of oriented angles of the gravure-printed AgNWs lines with 150 μm line widths. FIG. 3F and FIG. 3G show histograms and polar diagrams of oriented angles of the gravure-printed AgNWs lines with 50 μm line widths.

FIG. 4A shows achematic illustration of the post-printing treatment process. FIG. 4B shows the resistance changes upon the different treatment cycles. FIG. 4C shows schematic illustration of the mechanism of post-printing treatment. FIG. 4D shows high resolution SEM image of the line after post-printing treatment cycles of six.

FIG. 5A shows measured resistance of the gravure-printed AgNW lines at different length and with various line widths. FIG. 5B shows calculated sheet resistance of the gravure-printed AgNW lines with various line widths. FIG. 5C shows calculated conductivity of the gravure-printed AgNW lines with various line widths. At least three samples were tested for each line width.

FIG. 6A shows photograph of the bending test process. FIG. 6B shows resistance changes of AgNW line as a function of tensile bending radius and bending strain. FIG. 6C shows dynamic bending fatigue tests of AgNW line at the bending radii of 30, 25, 20, 15, 10, 7.5 and 5 mm, respectively. FIG. 6D shows optical image of the printed 150 μm-width AgNW grid with line spacing of 500 μm.

FIG. 7A shows SEM image and TEM image (inset of (FIG. 7A)) of the as-synthesized AgNWs. FIG. 7B shows XRD peaks of the as-synthesized AgNWs.

FIG. 8 shows optical image of three AgNW lines with the same width of 50 μm and the same spacing of 100 μm.

FIG. 9 shows SEM image of the edge of the printed line.

FIG. 10 shows line thickness profiles measured by optical profilometry before treatment and after treatment cycles of six.

FIG. 11 shows SEM image of the line before post-printing treatment.

FIG. 12 shows resistance change of the printed AgNW line after post-printing treatment versus cycles in adhesion test.

FIG. 13 shows photographs of different gravure-printed AgNW patterns: lines, curves, Greek cross fractal pattern and AgNW grid.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y’, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 0.5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the term “effective amount” refers to an amount that is sufficient to achieve the desired modification of a physical property of the composition or material.

As used herein, the terms “optional” or “optionally” means that the subsequently described event or circumstance can or cannot occur, and that the description includes instances where said event or circumstance occurs and instances where it does not.

Unless otherwise specified, temperatures referred to herein are based on atmospheric pressure (i.e. one atmosphere).

The term “gravure printing” used herein refers to a scheme of filling ink in a groove formed on a surface of a printing plate and removing ink in portions other than the groove to thereby transfer only the ink filled in the groove to an object to be printed.

The term “gravure plate” used herein refers to plates used in gravure printing. The gravure plate may be etched or engraved. During printing process, the gravure plate may be smeared with ink, the higher surface is wiped clean, and the ink left in recess area of the gravure plate will make the print.

The term “gravure cylinder” used herein refers to a cylinder with engraving on the surface of the cylinder. In one embodiment, a gravure cylinder includes a steel cylinder base, or an underlying metal structure that supports the engraved image-carrying layer.

The term “thixotropic behavior” used herein refers to fluids that are non-Newtonian fluids, i.e. which can show a time-dependent change in viscosity. The term “non-Newtonian” refers to fluid having a viscosity that is dependent on an applied force such as shear or thermal forces. For example, shear thinning fluids decrease in viscosity with increasing rate of shear. The greater chemical fluid of the water barrier layer undergoes shear stress, the lower its viscosity will be. When the share stress is removed, the viscosity can be re-built up.

The term “aspect ratio” used herein refers to the ratio of its longer dimension to its shorter dimension.

Reference throughout this specification to “one embodiment”, “an embodiment”, “another embodiment”, “some embodiment,” means that a particular feature, structure or characteristic described in connection with the embodiment is included in at least one embodiment of the present invention. Thus, appearances of the phrases “in one embodiment,” “in an embodiment,” “in another embodiment”, or “in some embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention. For example, in the appended claims, any of the claimed embodiments can be used in any combination.

### DESCRIPTION

Gravure printing is a promising technique for large-scale printed electronics. However, gravure printing of silver nanowires (AgNWs) so far has been limited in terms of resolution and electrical conductivity. In one aspect, gravure printing of water-based AgNW ink on a flexible substrate is demonstrated. By tailoring the ink properties, printing conditions and post-printing treatment, gravure printing enables printing of high-resolution, highly conductive AgNW patterns in large areas, with resolution as fine as 50 μm and conductivity as high as 5.34×10⁴S cm⁻¹. The printed AgNW patterns on the flexible substrate show excellent flexibility under repeated bending. All of these characteristics demonstrate the excellent potential of gravure printing of AgNWs for developing large-area flexible electronics.

In one aspect, the present disclosure provides large-scale, high-resolution patterning of AgNWs by gravure printing. A new type of water-based AgNW ink was developed. Rheological behavior of the ink was investigated to correlate the ink compositions, the rheological properties and the printing results. By tailoring the ink properties and printing conditions, continuous lines with resolution as fine as ˜50 μm were achieved over large areas with notable reliability and uniformity. The conductivity of the printed AgNW lines was measured to be as high as 5.34×10⁴ S cm⁻¹. In addition, the printed AgNW lines on a flexible polyethylene terephthalate (PET) film showed excellent flexibility under repeated bending.

In one aspect, the present disclosure provides an ink composition including a plurality of metal nanowires, one or more water soluble polymers, and an aqueous liquid carrier. In one embodiment, the plurality of metal nanowires includes silver nanowires. In one embodiment, the plurality of metal nanowires has an average longitudinal dimension of from about 10 micrometers to about 100 micrometers (μm), from about 10 μm to about 90 μm, from about 10 μm to about 80 μm, from about 10 μm to about 70 μm, from about 10 μm to about 60 μm, from about 10 μm to about 50 μm, from about 10 μm to about 40 μm, from about 10 μm to about 30 μm, or from about 10 μm to about 20 μm. In one embodiment, the plurality of metal nanowires has an average longitudinal dimension of about 10 μm, 20 μm, 30 μm, 40 μm, 50 μm, 60 μm, 70 μm, 80 μm, 90 μm, or 100 μm.

In one embodiment, the plurality of metal nanowires has an average diameter of from about 10 nm to about 200 nm, about 20 nm to about 100 nm, about 30 nm to about 100 nm, about 40 nm to about 100 nm, about 50 nm to about 100 nm, about 60 nm to about 100 nm, about 70 nm to about 100 nm, or about 80 nm to about 100 nm. In one embodiment, the plurality of metal nanowires has an average diameter of about 60 nm, 65 nm, 70 nm, 75 nm, 80 nm, 85 nm, 90 nm, 95 nm, or 100 nm. In one embodiment, the plurality of metal nanowires has an average aspect ratio of greater than or equal to about 50:1, or greater than or equal to about 100:1, or greater than or equal to about 150:1, or greater than or equal to about 200:1, or greater than or equal to about 300:1. In one embodiment, the plurality of metal nanowires has an average aspect ratio of from about 50:1 to about 1000:1, from about 100:1 to about 1000:1, from about 150:1 to about 1000:1, from about 200:1 to about 1000:1, from about 300:1 to about 1000:1, or from about 400:1 to about 1000:1. In one embodiment, the plurality of metal nanowires has an average aspect ratio of about 50:1, 100:1, 150:1, 200:1, 250:1, 300:1, 350:1, 400:1, 450:1, 500:1, or 550:1.

In one embodiment, the ink composition includes from about 1 weight percent (wt %) to about 10 wt % metal nanowires, from about 2 wt % to about 9 wt % metal nanowires, 2.5 wt % to about 7.5 wt % metal nanowires, from about 3 wt % to about 7 wt % metal nanowires, or from about 4 wt % to about 6 wt % metal nanowires, based on the weight of the entire ink composition. In one embodiment, the ink composition includes about 1 wt %, 2 wt %, 3 wt %, 4 wt %, 5 wt %, 6 wt %, 7 wt %, 8 wt %, 9 wt %, or 10 wt % metal nanowires based on the weight of the entire ink composition.

In one embodiment, the one or more water soluble polymers includes a poly(ethylene oxide) polymer, optionally having a molecular weight of about 1,000,000 Dalton. In one embodiment, the one or more water soluble polymers includes a polyvinylpyrrolidone polymer. In one embodiment, the aqueous liquid carrier includes water, and optionally a co-solvent including an alcohol; optionally the alcohol includes methanol, ethanol, n-propanol, or n-butanol.

In one embodiment, the ink composition includes up to about 96 wt % aqueous liquid carrier, based on the weight of the entire ink composition. In one embodiment, the ink composition includes up to about 60 wt % water, based on the weight of the entire ink composition. In one embodiment, the ink composition has thixotropic behavior. In one embodiment, the ink composition has a capillary number (Ca) of about 0.8 to about 1.2, optionally from about 0.9 to about 1.1, optionally about 1.0. In one embodiment, the ink composition further includes one or more additives comprising a surfactant, a dispersant, a corrosion inhibitor, a stabilizer, an adhesion promoter, an antioxidant, a viscosity modifier, or a combination or mixture thereof.

In one aspect, the present disclosure provides a method of gravure printing a metal nanowire structure onto a substrate including the steps of depositing a first quantity of the ink composition described herein into one or more cavities in a gravure plate; transferring the ink composition from the one or more cavities onto a substrate; and removing at least a portion of the liquid carrier and at least a portion of the one or more water soluble polymers from the ink composition to form a metal nanowire structure comprising a plurality of metal nanowires disposed on the substrate.

In one embodiment, the gravure plate is a gravure cylinder. In one embodiment, the step of depositing the ink composition comprises applying a second quantity of ink to the gravure plate that is in excess of the first quantity, and removing the excess quantity of the ink composition from the gravure plate with a doctor blade. In one embodiment, the step of transferring the ink composition includes directly transferring the ink composition to the substrate by directly contacting the substrate with the surface of the gravure plate, resulting in the transfer of the ink composition from the one or more cavities to the substrate. In one embodiment, the step of transferring the ink composition includes transferring the ink composition to a transfer surface, and contacting the substrate with the transfer surface resulting in a transfer of the ink composition to the substrate.

In one embodiment, the step of removing the one or more water soluble polymers includes one or more iterations of: increasing the temperature of the ink composition to a first temperature; and rinsing the ink composition with water. In one embodiment, the method includes from 1 to 10 iterations of increasing the temperature and rinsing; optionally from 1 to 8 iterations, from 1 to 7 iterations, or from 1 to 6 iterations, from 1 to 5 iterations, from 1 to 4 iterations or from 1 to 3 iterations. In one embodiment, the first temperature is at or above a glass transition temperature of one of the water soluble polymers. In one embodiment, the increasing the temperature of the ink composition further includes thermal annealing of one or more of the metal nanowires. In one embodiment, the substrate is a flexible substrate.

In one embodiment, the method forms a metal nanowire structure having a smallest dimension of less than about 100 μm, optionally less than about 90 μm, or less than about 80 μm or less than about 70 μm, or less than about 60 μm, or about 50 μm. In one embodiment, the metal nanowire structure has a smallest dimension of about 1-100 μm, about 5-90 μm, about 5-80 μm, about 5-70 μm, about 5-60 μm, about 5-50 μm, about 5-40 μm, or about 5-30 μm. In one embodiment, the metal nanowire structure has a smallest dimension of about 5 μm, 10 μm, 20 μm, 30 μm, 40 μm, 50 μm, 60 μm, 70 μm, 80 μm, 90 μm, or 100 μm. In one embodiment, the metal nanowire structure includes a structure formed by the method described herein. In one embodiment, the metal nanowire structure includes a one-dimensional pattern, a two-dimensional pattern, or a combination thereof.

In one embodiment, the metal nanowire structure includes one or more of a line, a curve, a fractal pattern, a grid, or a combination thereof. In one embodiment, the metal nanowire structure includes two or more interconnected metal nanowire structures. In one embodiment, the metal nanowire structure includes a three-dimensional pattern. In one embodiment, the plurality of metal nanowires in the metal nanowire structure are oriented along a first direction. In one embodiment, at least 30% of the metal nanowires have a longitudinal dimension within plus or minus 15 degrees the first direction.

In one embodiment, a metal nanowire structure having a length of up to 3 centimeters has an electrical conductivity of greater than about 3.5×10⁴ S cm⁻¹, optionally greater than 4.0×10⁴ S cm⁻¹, or greater than 4.5×10⁴ S cm⁻¹, or greater than 5.0×10⁴ S cm⁻¹. In one embodiment, a metal nanowire structure having a length of up to 3 centimeters has an electrical conductivity from about 3.5×10⁴ S cm⁻¹ to about 3.5×10⁵ S cm⁻¹, from about 4.0×10⁴ S cm⁻¹ to about 4.0×10⁵ S cm⁻¹, from about 4.5×10⁴ S cm⁻¹ to about 4.5×10⁵ S cm⁻¹, from about 5.0×10⁴ S cm⁻¹ to about 5.0×10⁵ S cm⁻¹, from about 5.5×10⁴ S cm⁻¹ to about 5.5×10⁵ S cm⁻¹, In one embodiment, a metal nanowire structure having a length of up to 3 centimeters has a resistance of less than about 260Ω, optionally less than about 200Ω, or less than about 150Ω, or less than about 100Ω. In one embodiment, a metal nanowire structure having a length of up to 3 centimeters has a resistance of about 1-500Ω, 1-400Ω, 1-300Ω, 1-260Ω, 1-200Ω, 1-150Ω, 1-100Ω, or 1-50Ω. In one embodiment, a metal nanowire structure having a length of up to 3 centimeters has a resistance of about 50Ω, 100Ω, 150Ω, 200Ω, 250Ω, or 300Ω.

In one embodiment, the metal nanowire structure is bendable. In one embodiment, the metal nanowire structure maintains a constant resistance (R/R₀=1) up to a tensile bending strain about 1.25%. In one embodiment, the metal nanowire structure maintains a constant resistance (R/R₀=1) over 500 cycles up to a tensile bending strain of about 1.25%.

### EXAMPLES

### Example 1

### Materials and Methods

Materials. The reagents used in this study included silver nitrate (AgNO₃), poly(vinylpyrrolidone) (PVP, K-30), sodium chloride (NaCl), ethylene glycol (EG), acetone, ethanol, Poly(ethylene oxide) (PEO, average Mᵥ ˜1,000,000). All reagents were of analytical grade and purchased from Sigma Aldrich. All chemicals were used as received without further purification.

Synthesis of AgNWs. AgNWs were fabricated using a modified polyol reduction method (Ref. 55). PVP solution (50 mL 0.09 M in EG) was heated to 170° C. in a three-neck flask with stirring at 300 rpm for 1 h. NaCl solution (150 μL 0.1 M in EG) was then added and stirred for 10 min. AgNO₃ solution (50 mL 0.06 M in EG) was subsequently added to the flask dropwise at a rate of 2.5 mL min⁻¹. After the AgNO₃ solution was added to the flask, the oil bath reaction lasted another 20 min. The clear solution changed color to glistening gray, which indicated the formation of AgNWs. Then the solution was cooled to room temperature and was centrifuged at 2000 rpm for 10 min with acetone and ethanol, respectively, to remove solvent (EG), surfactant (PVP) and other impurities (e.g. small amount of Ag nanoparticles) in the supernatant.

Preparation of AgNW Inks. Poly(ethylene oxide) (PEO, average My ˜1,000,000) was purchased from Sigma Aldrich and used as received. 4 wt % PEO solution was prepared by dissolving PEO powder in a mixed solvent of ˜50 wt % deionized water (DI water) and ˜46 wt % ethanol. AgNWs with different weight content were added into the PEO solution and the as-prepared inks were stirred with magnetic stir bar the speed of 1000 rpm for 60 min to ensure uniform AgNW inks.

Gravure Printing and Post-Printing Treatment of AgNW Patterns. Inverse direct gravure printing system, which used a flat printing plate to transfer patterns to a substrate on a roll, was set up. The flat printing plate, which contained engraved intaglio trenches, was fabricated by laser cutting of flat clear cast acrylic sheet (McMaster-Carr) using a laser cutter (VLS 6.60, Universal Laser Systems). Trenches with different width were obtained by controlling the power of the laser beam and the depths of all trenches were ˜60 μm. A stainless steel cylinder with diameter of 25 mm was used as an impression roller. Polyethylene terephthalate film (PET, MELINEX® 454, Dupont) with thickness of 125 μm was first treated with plasma cleaner (PDC-32G, Harris Plasma) for 1 min to enhance the hydrophilic property and then wrapped around the printing roller by an elastic double-sided tape. The angle between the printing plate and the doctor blade was fixed at 75°. The printing speed was ˜1.5 mm·s⁻¹. The printed AgNW patterns were first annealed on a hot plate at 150° C. for 2 min to evaporate the water and ethanol, followed by washing with DI water at 70° C. for 10 min to remove part of PVP and PEO. The thermal annealing and water washing process were repeated several times. Finally, the coating was annealed at 150° C. for 5 min to help fuse the AgNW junctions, and the final conductive AgNW patterns were obtained.

Characterization. The morphologies of the as-synthesized AgNWs and the gravure-printed AgNWs lines were tested by field-emission scanning electron microscopy (SEM, FEI Quanta 3D FEG) operated at 5 kV. The transmission electron microscope (TEM) image of the as-synthesized AgNWs was obtained by field emission ultra-high resolution scanning transmission electron microscope (Field Emission STEM, JEOL 2010F). The structural characterization of the AgNW films was performed using X-ray diffraction (XRD, Rigaku SmartLab X-Ray Diffractometer) with Cu Kα radiation (λ=0.1542 nm). Rheological behavior of the AgNW inks was measured using a Haake VT500 viscotester system. A pre-conditioning step at a shear rate of 0.1 s⁻¹ for 10 s was applied before each test to assure uniformity of the fluids and all of the tests were done at room temperature (25° C.). Surface tension of the AgNW inks was tested by Ramé-Hart contact angle goniometer at room temperature (25° C.). The dimensions of the gravure-printed AgNW lines were obtained by using an optical microscope (Nikon Eclipse). Alignment of AgNWs in the gravure-printed line patterns was analyzed with ImageJ software and at least 100 AgNWs for each line were analyzed. Thickness of the gravure-printed AgNW patterns was measured by a Dektak profilometer. A Fluke 115 true RMS multimeter was used to measure the resistance of the printed AgNW lines. The mechanical stability test was performed using a lab-made bending test machine. Scotch tape was used to evaluate the adhesion of the printed AgNW line after post-printing treatment. Scotch tape was applied on the samples and after pressing them on the substrate by hands the tape was peeled off slowly.

Calculation of sheet resistance of the gravure-printed AgNW lines. According to the formula

$$ρ = R \frac{A}{L} and s = \frac{ρ}{h} ,$$

where ρ is the electrical resistivity of the printed lines, A is the cross-sectional area of the printed lines, L is the length of the printed lines, Rs is the sheet resistance of the printed lines and h is the thickness of the printed lines. Thus, sheet resistance can be calculated by

$$R s = R \frac{A}{L \times h} .$$

The length of the printed lines was 3 cm for all samples. The resistance of the printed lines can be measured by a multimeter, while the cross section and thickness of the printed lines can be measured by a Dektak profilometer. The cross section area and the thickness of the printed lines were integral area and average thickness, respectively.

### Example 2

### Synthesis and Property of AgNWs Inks

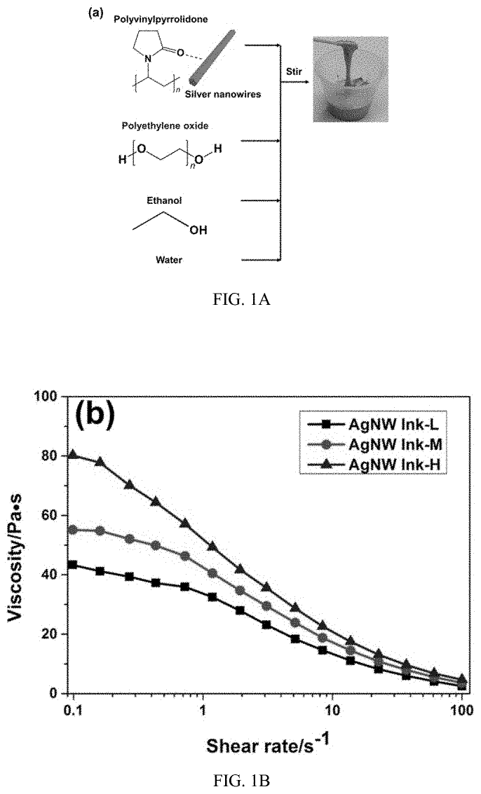

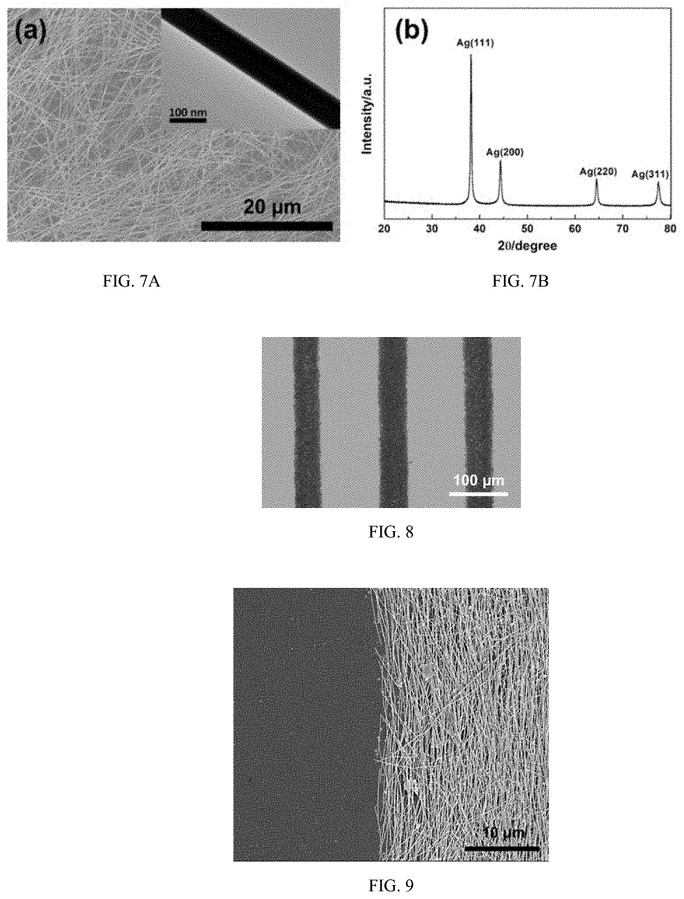

The AgNWs synthesized by the modified polyol reduction method were characterized by SEM and TEM, as shown in FIG. 7A. The AgNWs present a relatively high aspect ratio (˜200) with an average diameter of 80 nm and average length of 15 μm. FIG. 7B shows the XRD pattern of dried AgNWs. The four strongest peaks can be observed at 38.2°, 44.4°, 64.5° and 77.5°, which were attributed to the diffraction of the (111), (200), (220) and (311) crystalline planes of the face-centered structure of silver, respectively, according to the Silver Joint Committee on Powder Diffraction Standards Database (JCPDS, File No. 04-0783). The printed conductor consists of AgNWs in the form of a percolation network. To formulate the AgNW ink for gravure printing, several properties, including stabilization of AgNWs in the ink and wetting, spreading, adhesion and drying of printed AgNW patterns, should be optimized. These properties are crucial for the fabrication of high-resolution, uniform AgNW patterns. The ink was prepared by adding AgNWs to a viscous poly(ethylene oxide) (PEO) solution with DI water and ethanol as co-solvents (FIG. 1A). DI water was chosen as the major solvent due to its environmental friendliness and low cost. Due to the high surface tension of DI water (72.8 mN·m⁻¹ at 20° C.), DI water alone is usually undesirable, which tends to result in aggregation of AgNWs as a result of contact line recession and dewetting during evaporation. Thus, nontoxic ethanol with a low boiling point and a lower surface tension (22.5 mN·m⁻¹ at 20° C.) was added.

Viscosity is the most important ink parameter to tailor. PEO, a flexible, non-ionic water-soluble polymer used in a wide variety of applications, was used to assist ink formulation for the following reasons (Ref. 45, 46). First, PEO has a high molecular weight (average Mv ˜1,000,000), which can increase the viscosity of the ink dramatically, and provides thixotropic behavior for the AgNW ink; second, PEO can function as a dispersive agent to improve dispersion of AgNWs as the hydroxy groups can bond with the surface of the AgNWs; third, PEO is also alcohol-soluble and can precipitate together with AgNWs to generate solid composite sediments with good redispersion capability, which is conducive to forming a uniform, continuous pattern. In a typical formulation, DI water, ethanol and PEO were mixed by stirring at a weight ratio of 12.5:11.5:1 for 24 h to make homogeneous solution. Then, AgNWs were added into the solution to make the gravure-printing inks with three different AgNW solid contents: 3.0 wt % (AgNW Ink-L), 3.7 wt % (AgNW Ink-M) and 5.0 wt % (AgNW Ink-H). The inks were stirred for 10 min to obtain the final stable AgNW inks. As-prepared viscous AgNW Ink-H is shown in FIG. 1A. The surface tensions of the three inks were 32.6, 30.2 and 28.8 mN·m⁻¹, respectively.

The rheological behavior of the AgNW inks was investigated to determine how the AgNW solid content affected the ink properties. FIG. 1B shows that all three inks exhibited a shear thinning thixotropic behavior—viscosities of the inks decrease as the shear rate increases. At the same shear rate the AgNW ink with higher solid content exhibited higher viscosity. For example, the viscosities at the shear rate of 10 s⁻¹ for the AgNW Ink-L, AgNW Ink-M, and AgNW Ink-H were 13.4, 16.9 and 20.9 Pa·s, respectively. This is because nanowires can act as an active cross-linker, leading to enhanced network strength and hence increased viscosity. The capillary number (Cₐ) is a dimensional quantity to describe the relative effect of viscosity versus surface tension. Cₐ is defined as

$${C}_{a} = \frac{η U}{γ}$$

where η is the ink's viscosity, γ is the ink's surface tension and U is the printing speed (˜1.5 mm·s⁻¹ in this work). After calculation, the Cₐ for the AgNW Ink-L, AgNW Ink-M, and AgNW Ink-H were 0.62, 0.84, and 1.09, respectively. According to Ref. 20, at very low capillary number (Cₐ<1), pattern fidelity was deteriorated by ink drag-out from the cells; at very high capillary number (Cₐ>1), inefficient doctoring left ink in non-patterned areas. Optimal printing can be achieved by adjusting the printing speed and the ink parameters to make Cₐ≈1 (Ref. 20). Accordingly, the ink with a concentration of 5.0 wt % (AgNW Ink-H) was selected for printing in the rest of this work, as it possessed the rheological properties that best meet the printability.

### Example 3

### Gravure Printed AgNW

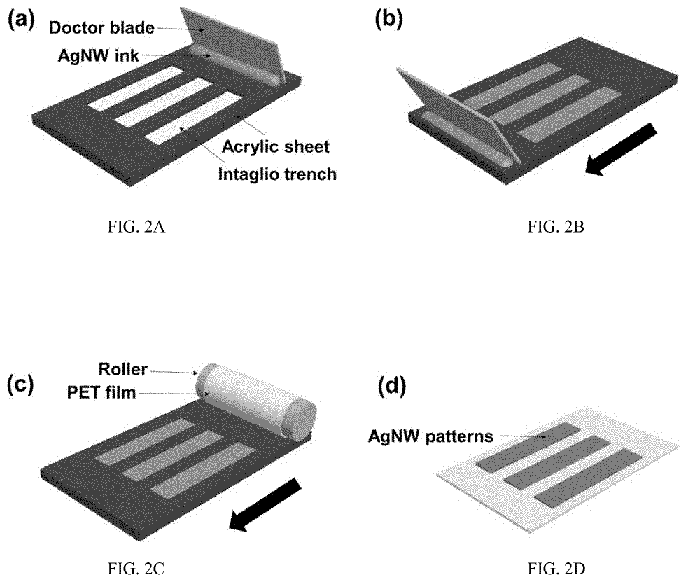

Inverse direct gravure printing was used to print AgNW patterns, as shown schematically in FIG. 2A-D. The printing process includes four steps: (1) applying ink to the gravure plate; (2) filling ink in the gravure trenches while removing the excess ink by a doctor blade; (3) transferring ink onto a flexible substrate on the roller; and (4) releasing the substrate from the roller. Acrylic sheet was used as the gravure plate in this work, and the trenches were fabricated by laser engraving. Trenches with different widths were obtained by adjusting the laser power. Unlike engraved cells used for printing silver nanoparticle inks (Ref. 24) and graphene inks (Ref. 29), long, continuous intaglio trenches (Ref. 47) were fabricated for the AgNW inks due to the large length of AgNWs. In the printing process, as shown in FIG. 2B, the ink filling and removing were operated at the same time by a doctor blade. A flexible PET film was mounted onto the roller and the ink was transferred onto the PET film as the roller rolled across the acrylic sheet (FIG. 2C). After releasing from the roller, gravure-printed conductive AgNW patterns were fabricated on the PET film (FIG. 2D).

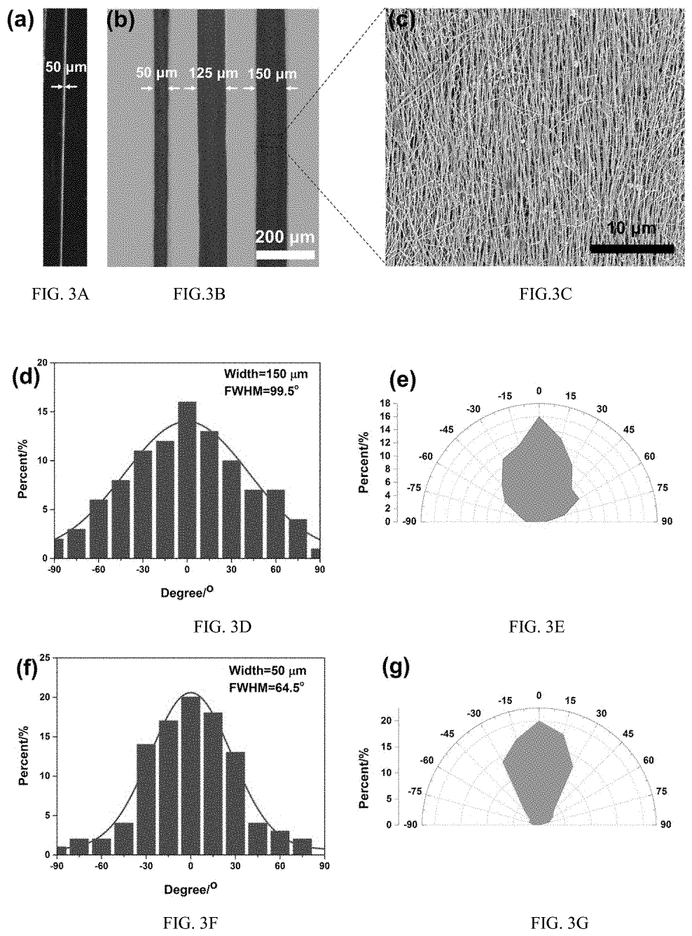

FIG. 3A shows the photograph of a gravure printed AgNW line with length of 3 cm and width of 50 μm. The AgNW line appeared to be continuous with uniform width and no voids. FIG. 3B also shows an optical image of three AgNW lines with different widths (50, 100 and 125 μm) and the same spacing of 100 μm. Moreover, FIG. 8 shows an optical image of three AgNW lines with the same width of 50 μm and the same spacing of 100 μm. The edges of these lines were smooth and uniform. Further decreasing the line width or spacing would cause non-uniformity of the printed patterns. Thus, the printed resolution of line width and spacing between the lines can achieve 50 μm and 100 μm, respectively. During printing the doctor blade introduces shearing force to the AgNWs, which can align the AgNWs to the printing direction especially for those near the edges of the printed lines. This is similar to the case of patterning and alignment of AgNWs by manipulating wetting of dispersions in microchannels (Ref. 48). The printed AgNWs formed a dense percolation network and showed good alignment to the printing direction (FIGS. 3C and 9). The alignment was found to depend on the line width. FIGS. 3D, F show the distribution of the AgNW angles with respect to the printing direction for line widths of 150 μm and 50 μm, respectively. The AgNWs are better aligned along the printing direction for smaller line width. Full width at half-maximum (FWHM) values are also shown in FIGS. 3D, F. As AgNW line width decreases from 150 μm to 50 μm, FWHM decreases from 99.5° to 64.5°. To better visualize the distribution of alignment of AgNWs, the histograms were plotted into polar diagrams. As shown in FIGS. 3E, G, the distribution of orientation angles starts from being a rather wide, radiative shape to being a narrow, ellipse shape with AgNW line width decreasing from 150 μm to 50 μm. Better alignment of AgNWs may contribute to improving electrical conductivity of the printed AgNW patterns (Ref. 48, 49).

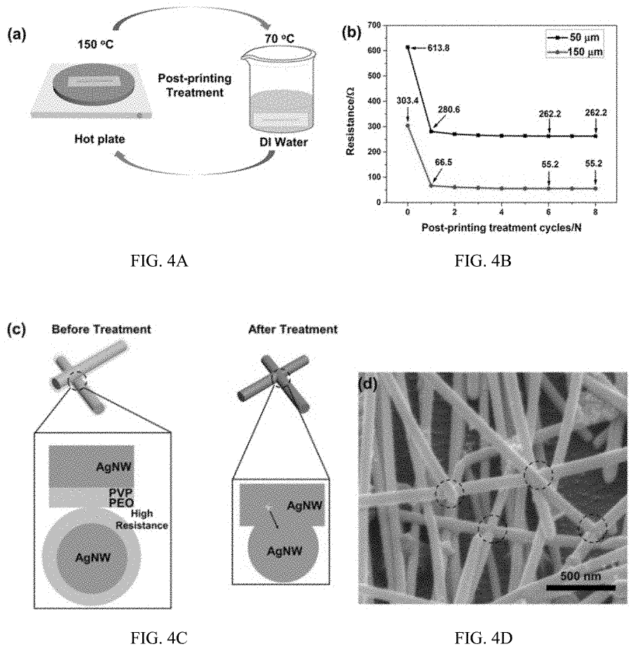

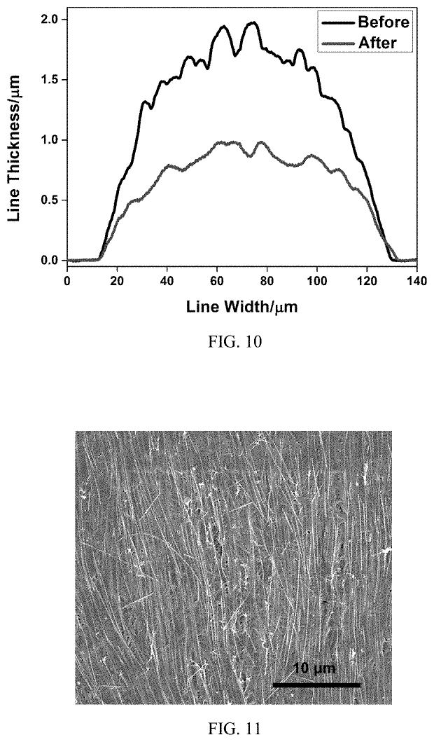

Two types of water-soluble polymers existed in the AgNW inks—poly(vinylpyrrolidone) (PVP) coating that was introduced to control the growth of AgNWs during the synthesis (also serving as a surfactant that helps disperse AgNWs in solutions) and PEO that was used as the additive for formulating the AgNW inks. These non-conductive polymers can be seen as barriers to electron transport, so the printed AgNWs had relatively high electrical resistance. After gravure printing, post-printing treatment of the AgNW patterns, including thermal annealing and water washing, was developed to improve the electrical conductivity. FIG. 4A shows the treatment cycles between thermal annealing (i.e. fusing the AgNW junctions at relative low temperature and not degrading the PET film, 150° C. for 2 min) and washing of the polymers (both PVP and PEO) in warm DI water (70° C. for 10 min). PVP glass transition temperature is around 150° C. Thus heating at 150° C., the mobility of PVP will significantly increase, which, when combined with water washing, will lead to their removal from the surface of the AgNWs and the junctions (Ref. 50), allowing a more intimate contact between AgNWs and thus a better electrical conduction of the network. Moreover, during water washing process, water soluble PVP and PEO can also be removed. The water washing process can further dissolve the PVP and PEO in the AgNW patterns. Thus, the post-printing treatment time and temperature are effective to remove most of the PVP. To obtain final AgNW patterns, the post-printing treated AgNW patterns were annealed at 150° C. for 5 min. Both steps are compatible with the polymeric substrate. To determine the number of treatment cycles, two typical lines with line width of 50 μm and 150 μm were gravure-printed on a PET film. For both lines electrical resistance was measured as a function of the number of treatment cycles, as shown in FIG. 4B. It can be seen that even for different line widths, the trend of the resistance change was nearly the same: the resistance decreased sharply after the first treatment cycle and then gently with increasing number of cycles until the sixth cycle, after which the resistance remained constant. The resistance drop was attributed to the removal of PVP and PEO from the AgNW lines, which apparently happened most dramatically during the first cycle. PVP and PEO were nearly completely removed after the sixth cycle. Thus, the number of treatment cycles used in this work was six. Interestingly, the height of the 125 μm-width AgNW line decreased from ˜2 μm to ˜1 μm after the six treatment cycles (FIG. 10). FIGS. 11 and 3C show the SEM images of the AgNW lines before and after the post-printing treatment, respectively.

The mechanism of the post-printing treatment was further investigated. As shown in FIG. 4C, before post-printing treatment, the PVP-coated AgNWs were surrounded by insulated PEO matrix that hindered electrons transfer between neighboring nanowires, thus the resistance was relatively high. During the treatment, most of the PVP and PEO was dissolved in the DI water. As observed in high-magnification SEM images (FIG. 4D), after the treatment, some AgNW were in contact or even fused with each other; the direct contact and the fused junctions can contribute to decreasing the resistance of the printed AgNWs. During the post-printing treatment, especially water washing process, the ability of PVP to adsorb water shows a positive effect on the final electrical properties. The originally rigid nanowires can become softer at high humidity as reported recently (Ref. 51-53), which can facilitate the contact and fusion between AgNWs during the water washing process. In addition, thermal annealing can assist with the fusion between AgNWs too (Ref. 32). It is important to include the water washing in the post-printing treatment. Thermal annealing alone would require 200° C. and above, which can damage the PET substrate.

### Example 4

### Gravure Printed AgNW Exhibits High Electrical Conductivity and Robust Mechanical Responses

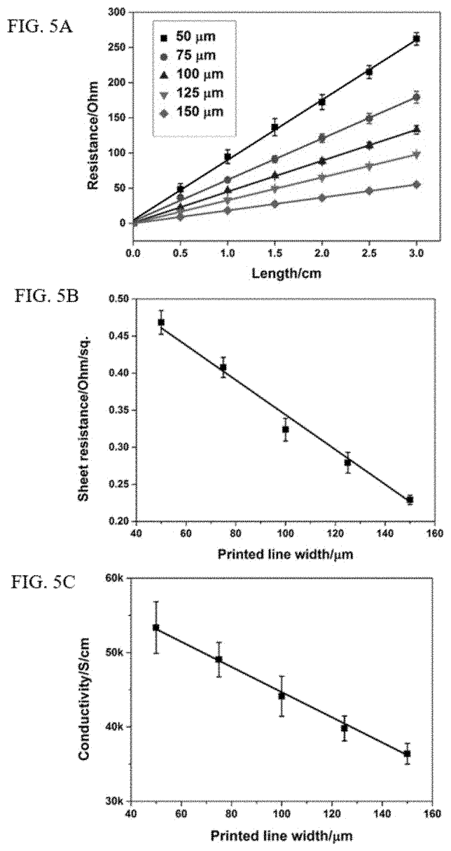

To evaluate the electrical properties of the printed AgNWs, 3 cm-length AgNW lines with widths of 50, 75, 100, 125 and 150 μm were gravure-printed on a PET film and treated with thermal annealing and water washing. FIG. 5A plots the measured resistance as a function of the length for all five AgNW lines.

A clear linear relationship, with the correlation factors over 0.998 in all cases, can be seen, which indicates excellent uniformity of the printed AgNW lines of different widths. It can also be seen that the resistance decreases with increasing width of the AgNW lines. For example, the resistances were measured to be 262.2±9.0, 179.2±8.4, 130.1±5.9, 98.1±1.1 and 55.2±0.4 0 for the line widths of 50, 75, 100, 125 and 150 μm, respectively, with the corresponding sheet resistances calculated to be 0.468±0.016, 0.408±0.014, 0.324±0.015, 0.279±0.014 and 0.229±0.006 Ωsq⁻¹ (FIG. 5B). It can be seen that the sheet resistance of the printed AgNW lines decreases slightly as the line width increases. Brief explanation behind the calculation of sheet resistances is provided above, which was similar to calculation used for screen-printed (Ref. 13) and electrohydrodynamic-printed (Ref. 54) AgNW lines. The electrical conductivity was further calculated following the equation:

$$σ = \frac{L}{R A}$$

where σ, R, L, and A are conductivity, resistance, the length and the cross-sectional area of the AgNW lines, respectively. Based on the measured resistances and the line geometries, the conductivities were calculated to be (5.34±0.35)×10⁴, (4.91±0.23)×10⁴, (4.41±0.27)×10⁴, (3.98±0.16)×10⁴and (3.64±0.14)×10⁴ S cm⁻¹ for the line widths of 50, 75, 100, 125 and 150 μm, respectively. It can be seen that the electrical conductivity decreases slightly as the printed line width increases. A similar trend was observed in screen-printed AgNW lines, which was attributed to the presence of voids in the AgNW patterns with larger line widths (Ref. 13). In this work, however, only a few voids were observed and this trend is more likely due to the NW alignment. The AgNWs showed better alignment along the printing direction for the narrower line, as compared to the wider line where a significant proportion of AgNWs were randomly oriented (FIGS. 3D, E). Better alignment can increase the electrical conductivity of the AgNWs. Table 1 compares the smallest line width and highest electrical conductivity of printed AgNW lines using several reported printing methods. It can be seen that by tailoring the ink properties and printing conditions, gravure printing can be used to print continuous AgNW lines with resolution as fine as ˜50 μm and electrical conductivity as high as 5.34×10⁴S cm⁻¹. The combination of high resolution and high conductivity is among the best for all the printed AgNW lines.

TABLE 1
Comparison of NW diameter, NW length, (smallest) printed
line width and (highest) electrical conductivity reported
for AgNWs using different printing methods.

| | NW | NW | Line | | |
|---|---|---|---|---|---|
| Printing | diameter | Length | width | Conductivity | |
| method | (nm) | (μm) | (μm) | (S · cm⁻¹) | Ref. |
| Inkjet | 55 | 2.2 | 1000 | 1 × 10³ | 56 |
| EHD-jet | 40 ± 7 | 20 ± 5 | 15 | Non-conductive | 46 |
| Screen | 25-35 | 15-25 | 50 | 4.67 × 10⁴ | 13 |
| Gravure | 50 | 22 | 230 | 1.81 × 10⁴ | 25 |
| Gravure | 80 | 15 | 50 | 5.34 × 10⁴ | This |
| | | | | | work |

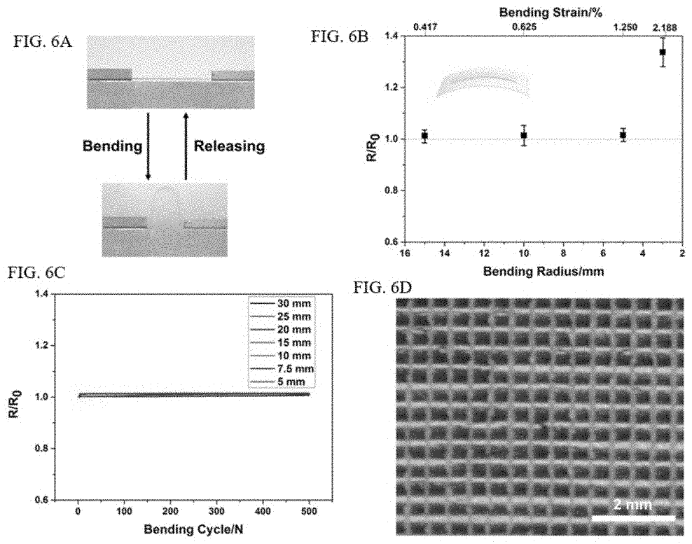

In addition to being highly conductive, the printed AgNW lines exhibited robust mechanical responses under tensile bending condition, which is of critical relevance to flexible electronics. The bending test (FIG. 6A) results revealed that the gravure-printed AgNW line (100 μm in width) maintained a constant resistance until the bending radius reached 3 mm, or an equivalent bending strain of 2.08%, as shown in FIG. 6B. FIG. 6C shows the cyclic bending test results for different bending radii (30, 25, 20, 15, 10, 7.5 and 5 mm). No obvious increase in resistance over 500 bending cycles to the smallest bending radius of ˜5.0 mm, which demonstrates the good mechanical flexibility and reliability of the gravure-printed AgNWs. As most of the PEO and PVP are removed from the printed AgNW lines, the poor adhesion of AgNWs and PET substrate can occur especially after about 50 times repeated cycles of adhering and peeling off (FIG. 12). On the other hand, the poor adhesion can make easier to transfer the printed AgNW lines onto other elastic substrates, e.g. by drop-casting liquid PDMS on top of the AgNW lines, which can be used as stretchable conductor (Ref. 31-40).

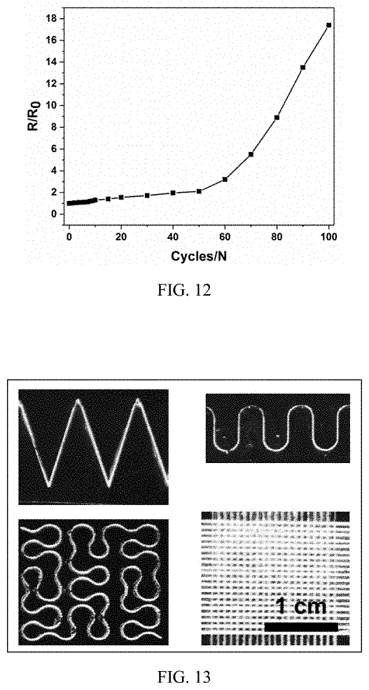

To demonstrate the general applicability of the developed gravure printing method, large-area and complicated AgNW patterns (e.g. lines, curves, Greek cross fractal patterns and grids) with different line widths and shapes were printed on PET films (FIG. 13). To print the AgNW grid, the lines parallel to the direction of printing were first printed. Then, by rotating the engraved plate by 90°, the orthogonal lines were printed. As shown in FIG. 6D, 150 μm-width lines were gravure-printed with line spacing of 0.5 mm. A well-known challenge for gravure printing is to print complicated patterns with arbitrary directions. As discussed above, to make sure the AgNW ink can fill in the trench, intaglio trenches were used in the experiments. While complicated patterns such as curves and Greek cross fractal patterns were printed, the well-known pickout effect in gravure printing might sometimes occur, where a small section of the printed patterns was different to transfer to the substrate (Ref. 47). Gravure printing of long one-dimensional nanomaterials such as AgNWs may be further developed.

### Example 5

### Integration of AgNWs with Gravure Printing Holds Promising Potential

Water-based AgNW inks were developed and gravure printed on flexible PET films. The AgNW ink, which contains a low solid content of 5.0 wt %, had a viscosity as high as 20.9 Pa s at 10 s-1 shear rate and appropriate rheological behavior suitable for gravure printing. Uniform and sharp-edged lines with resolution of 50 μm were obtained by gravure printing of the AgNW ink. Moreover, post-printing treatment with a low thermal annealing temperature of 150° C. and water washing was developed, which improved the electrical conductivity of the printed patterns to as high as 5.34×104 S cm⁻¹. In addition, gravure-printed large-area AgNW grids indicates that the integration of AgNWs with gravure printing holds promising potential for commercially relevant, highly scalable applications in printed and flexible electronics.

The present disclosure further includes the following embodiments/paragraphs.
1A. An ink composition comprising:
a plurality of metal nanowires;
one or more water soluble polymers; and
an aqueous liquid carrier.
2A. The ink composition of paragraph 1A, wherein the plurality of metal nanowires comprises silver nanowires.
3A. The ink composition of any one of the preceding paragraphs, wherein the plurality of metal nanowires has an average longitudinal dimension of from about 10 micrometers to about 20 micrometers.
4A. The ink composition of any one of the preceding paragraphs, wherein the plurality of metal nanowires has an average diameter of from about 60 nm to about 100 nm.
5A. The ink composition of any one of the preceding paragraphs, wherein the plurality of metal nanowires has an average aspect ratio of greater than or equal to about 150:1, or greater than about 200:1, or greater than about 300:1.
6A. The ink composition of any one of the preceding paragraphs, wherein the ink composition comprises from about 2.5 weight percent (wt %) to about 7.5 wt % metal nanowires, based on the weight of the entire ink composition, optionally from about 3 wt % to about 7 wt %, or about 4 wt % to about 6 wt %, or about 5 wt %.
7A. The ink composition of any one of the preceding paragraphs, wherein the one or more water soluble polymers comprises a poly(ethylene oxide) polymer, optionally having a molecular weight of about 1,000,000 Dalton.
8A. The ink composition of any one of the preceding paragraphs, wherein the one or more water soluble polymers comprises a polyvinylpyrrolidone polymer.
9A. The ink composition of any one of the preceding paragraphs, wherein the aqueous liquid carrier comprises water, and optionally a co-solvent comprising an alcohol; optionally the alcohol comprises methanol, ethanol, n-propanol, or n-butanol.
10A. The ink composition of any one of the preceding paragraphs, wherein the ink composition comprises up to about 96 wt % aqueous liquid carrier, based on the weight of the entire ink composition.
11A. The ink composition of any one of the preceding paragraphs, wherein the ink composition comprises up to about 60 wt % water, based on the weight of the entire ink composition.
12A. The ink composition of any one of the preceding paragraphs, wherein the ink composition has thixotropic behavior.
13A. The ink composition of any one of the preceding paragraphs, wherein the ink composition has a capillary number (Cₐ) of about 0.8 to about 1.2, optionally from about 0.9 to about 1.1, optionally about 1.0.
14A. The ink composition of any one of the preceding paragraphs, wherein the ink composition further comprises one or more additives comprising a surfactant, a dispersant, a corrosion inhibitor, a stabilizer, an adhesion promoter, an antioxidant, a viscosity modifier, or a combination or mixture thereof.
15A. A method of gravure printing a metal nanowire structure onto a substrate comprising:

depositing a first quantity of the ink composition according to any one of claims Error! Reference source not found. to Error! Reference source not found. into one or more cavities in a gravure plate;

transferring the ink composition from the one or more cavities onto a substrate; and

removing at least a portion of the liquid carrier and at least a portion of the one or more water soluble polymers from the ink composition to form a metal nanowire structure comprising a plurality of metal nanowires disposed on the substrate.
16A. The method of paragraph Error! Reference source not found.A, wherein the gravure plate is a gravure cylinder.
17A. The method of any one of paragraphs Error! Reference source not found.A-16A, wherein the step of depositing the ink composition comprises applying a second quantity of ink to the gravure plate that is in excess of the first quantity, and removing the excess quantity of the ink composition from the gravure plate with a doctor blade.
18A. The method of any one of paragraphs Error! Reference source not found.A to 17A, wherein the step of transferring the ink composition comprises directly transferring the ink composition to the substrate by directly contacting the substrate with the surface of the gravure plate, resulting in the transfer of the ink composition from the one or more cavities to the substrate.
19A. The method of any one of paragraphs Error! Reference source not found.A to 18A, wherein the step of transferring the ink composition comprises transferring the ink composition to a transfer surface, and contacting the substrate with the transfer surface resulting in a transfer of the ink composition to the substrate.
20A. The method of any one of paragraphs Error! Reference source not found.A to 19A, wherein the step of removing the one or more water soluble polymers comprises one or more iterations of: increasing the temperature of the ink composition to a first temperature; and rinsing the ink composition with water.
21A. The method of any one of paragraphs Error! Reference source not found.A to 20A, wherein the method comprises from 1 to 10 iterations of increasing the temperature and rinsing; optionally less than 8 iterations, or less than 7 iterations, or less than 6 iterations.
22A. The method of any one of paragraphs Error! Reference source not found.A to 21A, wherein the first temperature is at or above a glass transition temperature of one of the water soluble polymers.
23A. The method of any one of paragraphs Error! Reference source not found.A to 22A, wherein the increasing the temperature of the ink composition further comprises thermal annealing of one or more of the metal nanowires.
24A. The method of any one of paragraphs Error! Reference source not found.A to 23A, wherein the substrate is a flexible substrate.
25A. The method of any one of paragraphs Error! Reference source not found.A to 24A, wherein the method forms a metal nanowire structure having a smallest dimension of less than about 100 μm, optionally less than about 90 μm, or less than about 80 μm or less than about 70 μm, or less than about 60 μm, or about 50 μm.
26A. A metal nanowire structure comprising a structure formed by the method of any one of paragraphs Error! Reference source not found.A to Error! Reference source not found.A.
27A. The metal nanowire structure of paragraph Error! Reference source not found.A, wherein the metal nanowire structure comprises a one-dimensional pattern, a two-dimensional pattern, or a combination thereof.
28A. The metal nanowire structure of any one of paragraphs Error! Reference source not found.A to 27A, wherein the metal nanowire structure comprises one or more of a line, a curve, a fractal pattern, a grid, or a combination thereof.
29A. The metal nanowire structure of any one of paragraphs Error! Reference source not found.A to 28A, wherein the metal nanowire structure comprises two or more interconnected metal nanowire structures.
30A. The metal nanowire structure of any one of paragraphs Error! Reference source not found.A to 29A, wherein the metal nanowire structure comprises a three-dimensional pattern.
31A. The metal nanowire structure of any one of paragraphs Error! Reference source not found.A to 30A, wherein the plurality of metal nanowires in the metal nanowire structure are oriented along a first direction.
32A. The metal nanowire structure of any one of paragraphs Error! Reference source not found.A to 31A, wherein at least 30% of the metal nanowires have a longitudinal dimension within plus or minus 15 degrees the first direction.
33A. The metal nanowire structure of any one of paragraphs Error! Reference source not found.A to 32A, wherein a metal nanowire structure having a length of up to 3 centimeters has an electrical conductivity of greater than about 3.5×10⁴ S cm⁻¹, optionally greater than 4.0×10⁴ S cm⁻¹, or greater than 4.5×10⁴ S cm⁻¹, or greater than 5.0×10⁴ S cm⁻¹.
34A. The metal nanowire structure of any one of paragraphs Error! Reference source not found.A to 33A, wherein a metal nanowire structure having a length of up to 3 centimeters has a resistance of less than about 260Ω, optionally less than about 200Ω, or less than about 150Ω, or less than about 100Ω.
35A. The metal nanowire structure of any one of paragraphs Error! Reference source not found.A to 34A, wherein the metal nanowire structure is bendable.
36A. The metal nanowire structure of any one of paragraphs Error! Reference source not found.A to 35A, wherein the metal nanowire structure maintains a constant resistance (R/R₀=1) up to a tensile bending strain about 1.25%.
37A. The metal nanowire structure of any one of paragraphs Error! Reference source not found.A to 36A, wherein the metal nanowire structure maintains a constant resistance (R/R₀=1) over 500 cycles up to a tensile bending strain of about 1.25%.

The following references are incorporated herein in their entirety:
1. Berggren, M., Nilsson, D. & Robinson, N. D. Organic materials for printed electronics. Nat. Mater. 6,3-5, https://doi.org/10.1038/nmat1817 (2007).
2. Ahn, B. Y. et al. Omnidirectional printing of flexible, stretchable, and spanning silver microelectrodes. Science 323, 1590-1593, https://doi.org/10.1126/science.1168375 (2009).
3. Perelaer, J. et al. Printed electronics: The challenges involved in printing devices, interconnects, and contacts based on inorganic materials. J. Mater. Chem. 20, 8446-8453, https://doi.org/10.1039/c0jm00264 j (2010).
4. Perelaer, J. et al. Roll-to-roll compatible sintering of inkjet printed features by photonic and microwave exposure: From non-conductive ink to 40% bulk silver conductivity in less than 15 seconds. Adv. Mater. 24, 2620-2625, https://doi.org/10.1002/adma.201104417 (2012).
5. Kamyshny, A. & Magdassi, S. Conductive nanomaterials for printed electronics. Small 10,3515-3535, https://doi.org/10.1002/smll.201303000 (2014).
6. Yeshua, T. et al. Micrometer to 15 nm printing of metallic inks with fountain pen nanolithography. Small 14, 1702324, https://doi.org/10.1002/smll.201702324 (2018).
7. Choi, K. H., Yoo, J., Lee, C. K. & Lee, S. Y. All-inkjet-printed, solid-state flexible supercapacitors on paper. Energy Environ. Sci. 9, 2812-2821, https://doi.org/10.1039/c6ee00966b (2016).
8. Torrisi, F. et al. Inkjet-printed graphene electronics. ACS Nano 6, 2992-3006 (2012).
9. Kim, B. H. et al. High-resolution patterns of quantum dots formed by electrohydrodynamic jet printing for light-emitting diodes. Nano Lett. 15, 969-973, https://doi.org/10.1021/nl503779e (2015).
10. Jiang, J. et al. Fabrication of transparent multilayer circuits by inkjet printing. Adv. Mater. 28, 1420-1426, https://doi.org/10.1002/adma.201503682 (2016).
11. Hyun, W. J. et al. Screen printing of highly loaded silver inks on plastic substrates using silicon stencils. ACS Appl. Mat. Interfaces 7, 12619-12624, https://doi.org/10.1021/acsami.5b02487 (2015).
12. Hyun, W. J., Secor, E. B., Hersam, M. C., Frisbie, C. D. & Francis, L. F. High-resolution patterning of graphene by screen printing with a silicon stencil for highly flexible printed electronics. Adv. Mater. 27, 109-115, https://doi.org/10.1002/adma.201404133 (2015).
13. Liang, J., Tong, K. & Pei, Q. A water-based silver-nanowire screen-print ink for the fabrication of stretchable conductors and wearable thin-film transistors. Adv. Mater. 28, 5986-5996, https://doi.org/10.1002/adma.201600772 (2016).
14. Arapov, K. et al. Conductive screen printing inks by gelation of graphene dispersions. Adv. Funct. Mater. 26, 586-593, https://doi.org/10.1002/adfm.201504030 (2016).
15. Cao, X. et al. Fully screen-printed, large-area, and flexible active-matrix electrochromic displays using carbon nanotube thin-film transistors. ACS Nano 10, 9816-9822, https://doi.org/10.1021/acsnano.6b05368 (2016).
16. Secor, E. B., Prabhumirashi, P. L., Puntambekar, K., Geier, M. L. & Hersam, M. C. Inkjet printing of high conductivity, flexible graphene patterns. J. Phys. Chem. Lett. 4, 1347-1351, https://doi.org/10.1021/jz400644c (2013).
17. Shen, W., Zhang, X., Huang, Q., Xu, Q. & Song, W. Preparation of solid silver nanoparticles for inkjet printed flexible electronics with high conductivity. Nanoscale 6, 1622-1628, https://doi.org/10.1039/c3nr05479a (2014).
18. Vaithilingam, J. et al. Combined inkjet printing and infrared sintering of silver nanoparticles using a swathe-by-swathe and layer-by-layer approach for 3-dimensional structures. ACS Appl. Mat. Interfaces 9, 6560-6570, https://doi.org/10.1021/acsami.6b14787 (2017).
19. Zhu, H. et al. A gravure printed antenna on shape-stable transparent nanopaper. Nanoscale 6, 9110-9115, https://doi.org/10.1039/c4nr02036g (2014).
20. Scheideler, W. J. et al. Gravure-printed sol-gels on flexible glass: A scalable route to additively patterned transparent conductors. ACS Appl. Mat. Interfaces 7, 12679-12687, https://doi.org/10.1021/acsami.5b00183 (2015).
21. Kim, S. et al. Ultrathin high-resolution flexographic printing using nanoporous stamps. Sci. Adv. 2, e1601660, https://doi.org/10.1126/sciadv.1601660 (2016).
22. Cho, C.-K. et al. Mechanical flexibility of transparent PEDOT:PSS electrodes prepared by gravure printing for flexible organic solar cells. Sol. Energy Mater. Sol. Cells 95, 3269-3275, https://doi.org/10.1016/j.solmat.2011.07.009 (2011).
23. Hrehorova, E. et al. Gravure printing of conductive inks on glass substrates for applications in printed electronics. J. Disp. Technol. 7, 318-324, https://doi.org/10.1109/Jdt.2010.2065214 (2011).
24. Kang, H., Kitsomboonloha, R., Jang, J. & Subramanian, V. High-performance printed transistors realized using femtoliter gravure-printed sub-10 um metallic nanoparticle patterns and highly uniform polymer dielectric and semiconductor layers. Adv. Mater. 24, 3065-3069, https://doi.org/10.1002/adma.201200924 (2012).
25. Park, J. D., Lim, S. & Kim, H. Patterned silver nanowires using the gravure printing process for flexible applications. Thin Solid Films 586, 70-75, https://doi.org/10.1016/j.tsf.2015.04.055 (2015).
26. Scheideler, W. J. et al. A robust, gravure-printed, silver nanowire/metal oxide hybrid electrode for high-throughput patterned transparent conductors. J. Mater. Chem. C 4, 3248-3255, https://doi.org/10.1039/c5tc04364f (2016).
27. Lau, P. H. et al. Fully printed, high performance carbon nanotube thin-film transistors on flexible substrates. Nano Lett. 13, 3864-3869, https://doi.org/10.1021/nl401934a (2013).
28. Lee, W. et al. A fully roll-to-roll gravure-printed carbon nanotube-based active matrix for multi-touch sensors. Sci. Rep. 5, 17707, https://doi.org/10.1038/srep17707 (2015).
29. Secor, E. B. et al. Gravure printing of graphene for large-area flexible electronics. Adv. Mater. 26, 4533-4538, https://doi.org/10.1002/adma.201401052 (2014).
30. Xiao, Y. et al. Gravure printing of hybrid MoS2@S-rGO interdigitated electrodes for flexible microsupercapacitors. Appl. Phys. Lett. 107, 013906, https://doi.org/10.1063/1.4926570 (2015).
31. De, S. et al. Silver nanowire networks as flexible, transparent, conducting films: Extremely high DC to optical conductivity ratios. ACS Nano 3, 1767-1774, https://doi.org/10.1021/Nn900348c (2009).
32. Hu, L., Kim, H. S., Lee, J.-Y., Peumans, P. & Cui, Y. Scalable coating and properties of transparent, flexible, silver nanowire electrodes. ACS Nano 4, 2955-2963, https://doi.org/10.1021/nn1005232 (2010).
33. Xu, F. & Zhu, Y. Highly conductive and stretchable silver nanowire conductors. Adv. Mater. 24, 5117-5122 (2012).
34. Lee, P. et al. Highly stretchable and highly conductive metal electrode by very long metal nanowire percolation network. Adv. Mater. 24, 3326-3332, https://doi.org/10.1002/adma.201200359 (2012).
35. Lee, J. et al. Very long ag nanowire synthesis and its application in a highly transparent, conductive and flexible metal electrode touch panel. Nanoscale 4, 6408-6414, https://doi.org/10.1039/c2nr31254a (2012).
36. Liang, J. J. et al. Silver nanowire percolation network soldered with graphene oxide at room temperature and its application for fully stretchable polymer light-emitting diodes. ACS Nano 8, 1590-1600, https://doi.org/10.1021/nn405887k (2014).
37. Yao, S. & Zhu, Y. Wearable multifunctional sensors using printed stretchable conductors made of silver nanowires. Nanoscale 6, 2345-2352, https://doi.org/10.1039/c3nr05496a (2014).
38. Yao, S. & Zhu, Y. Nanomaterial-enabled stretchable conductors: Strategies, materials and devices. Adv. Mater. 27, 1480-1511, https://doi.org/10.1002/adma.201404446 (2015).
39. Lee, J. et al. A dual-scale metal nanowire network transparent conductor for highly efficient and flexible organic light emitting diodes. Nanoscale 9, 1978-1985, https://doi.org/10.1039/c6nr09902e (2017).
40. Kim, H. J., Sim, K., Thukral, A. & Yu, C. Rubbery electronics and sensors from intrinsically stretchable elastomeric composites of semiconductors and conductors. Sci. Adv. 3, e1701114, https://doi.org/10.1126/sciadv.1701114 (2017).
41. Kang, S. et al. Capillary printing of highly aligned silver nanowire transparent electrodes for high-performance optoelectronic devices. Nano Lett. 15, 7933-7942, https://doi.org/10.1021/acs.nanolett.5b03019 (2015).
42. Cho, S. et al. Large-area cross-aligned silver nanowire electrodes for flexible, transparent, and force-sensitive mechanochromic touch screens. ACS Nano 11, 4346-4357, https://doi.org/10.1021/acsnano.7b01714 (2017).
43. Kang, S. et al. Transparent and conductive nanomembranes with orthogonal silver nanowire arrays for skin-attachable loudspeakers and microphones. Sci. Adv. 4, eaas8772, https://doi.org/10.1126/sciadv.aas8772 (2018).
44. Hernandez-Sosa, G. et al. Rheological and drying considerations for uniformly gravure-printed layers: Towards large-area flexible organic light-emitting diodes. Adv. Funct. Mater. 23, 3164-3171, https://doi.org/10.1002/adfm.201202862 (2013).
45. Hu, M. et al. Flexible transparent PES/silver nanowires/PET sandwich-structured film for high-efficiency electromagnetic interference shielding. Langmuir 28, 7101-7106, https://doi.org/10.1021/Ia300720y (2012).
46. Lee, H., Seong, B., Kim, J., Jang, Y. & Byun, D. Direct alignment and patterning of silver nanowires by electrohydrodynamic jet printing. Small 10, 3918-3922, https://doi.org/10.1002/smll.201400936 (2014).
47. Sung, D., Vornbrock, A. D. & Subramanian, V. Scaling and optimization of gravure-printed silver nanoparticle lines for printed electronics. IEEE Trans. Compon. Packag. Technol. 33, 105-114, https://doi.org/10.1109/Tcapt.2009.2021464 (2010).
48. Yang, B. R. et al. Microchannel wetting for controllable patterning and alignment of silver nanowire with high resolution. ACS Appl. Mat. Interfaces 7, 21433-21441, https://doi.org/10.1021/acsami.5b06370 (2015).
49. Huang, Q., Al-Milaji, K. N. & Zhao, H. Inkjet printing of silver nanowires for stretchable heaters. ACS Appl. Nano Mater. 1, 4528-4536, https://doi.org/10.1021/acsanm.8b00830 (2018).
50. Lagrange, M. et al. Optimization of silver nanowire-based transparent electrodes: Effects of density, size and thermal annealing. Nanoscale 7, 17410-17423, https://doi.org/10.1039/c5nr04084a (2015).
51. Lee, J., Lee, I., Kim, T. S. & Lee, J. Y. Efficient welding of silver nanowire networks without post-processing. Small 9, 2887-2894, https://doi.org/10.1002/smll.201203142 (2013).
52. Yoon, S. S. & Khang, D. Y. Room-temperature chemical welding and sintering of metallic nanostructures by capillary condensation. Nano Lett. 16, 3550-3556, https://doi.org/10.1021/acs.nanolett.6b00621 (2016).
53. Liu, Y. et al. Capillary-force-induced cold welding in silver-nanowire-based flexible transparent electrodes. Nano Lett. 17, 1090-1096, https://doi.org/10.1021/acs.nanolett.6b04613 (2017).
54. Cui, Z., Han, Y., Huang, Q., Dong, J. & Zhu, Y. Electrohydrodynamic printing of silver nanowires for flexible and stretchable electronics. Nanoscale 10, 6806-6811, https://doi.org/10.1039/c7nr09570h (2018).
55. Huang, Q. et al. Highly thermostable, flexible, transparent, and conductive films on polyimide substrate with an AZO/AgNW/AZO structure. ACS Appl. Mat. Interfaces 7, 4299-4305, https://doi.org/10.1021/am508704u (2015).
56. Finn, D. J., Lotya, M. & Coleman, J. N. Inkjet printing of silver nanowire networks. ACS Appl. Mat. Interfaces 7, 9254-9261, https://doi.org/10.1021/acsami.5b01875 (2015).

It will be apparent to those skilled in the art that various modifications and variations can be made in the present disclosure without departing from the scope or spirit of the disclosure. Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. An ink composition comprising:
a plurality of metal nanowires;
one or more water soluble polymers; and
an aqueous liquid carrier.

2. The ink composition of claim 1, wherein the plurality of metal nanowires comprises silver nanowires.

3. The ink composition of claim 1, wherein the plurality of metal nanowires has an average longitudinal dimension of from about 10 micrometers to about 20 micrometers.

4. The ink composition of claim 1, wherein the plurality of metal nanowires has an average diameter of from about 60 nm to about 100 nm.

5. The ink composition of claim 1, wherein the plurality of metal nanowires has an average aspect ratio of greater than or equal to about 150:1.

6. The ink composition of claim 1, wherein the ink composition comprises from about

2. 5 weight percent (wt %) to about 7.5 wt % metal nanowires, based on the weight of the entire ink composition.

7. The ink composition of claim 1, wherein the one or more water soluble polymers comprises a poly(ethylene oxide) polymer.

8. The ink composition of claim 1, wherein the one or more water soluble polymers comprises a polyvinylpyrrolidone polymer.

9. The ink composition of claim 1, wherein the aqueous liquid carrier comprises water.

10. The ink composition of claim 1, wherein the ink composition comprises up to about 96 wt % aqueous liquid carrier, based on the weight of the entire ink composition.

11. The ink composition of claim 1, wherein the ink composition comprises up to about 60 wt % water, based on the weight of the entire ink composition.

12. The ink composition of claim 1, wherein the ink composition has thixotropic behavior.

13. The ink composition of claim 1, wherein the ink composition has a capillary number (Cₐ) of about 0.8 to about 1.2.

14. The ink composition of claim 1, wherein the ink composition further comprises one or more additives selected from the group consisting of a surfactant, a dispersant, a corrosion inhibitor, a stabilizer, an adhesion promoter, an antioxidant, a viscosity modifier, and a combination or mixture thereof.

15. A method of gravure printing a metal nanowire structure onto a substrate comprising:
depositing a first quantity of the ink composition according to claim 1 into one or more cavities in a gravure plate;
transferring the ink composition from the one or more cavities onto a substrate; and
removing at least a portion of the liquid carrier and at least a portion of the one or more water soluble polymers from the ink composition to form a metal nanowire structure comprising a plurality of metal nanowires disposed on the substrate.

16. The method of claim 15, wherein the gravure plate is a gravure cylinder.

17. The method of claim 15, wherein the step of depositing the ink composition comprises applying a second quantity of ink to the gravure plate that is in excess of the first quantity, and removing the excess quantity of the ink composition from the gravure plate with a doctor blade.

18. The method of claim 15, wherein the step of transferring the ink composition comprises directly transferring the ink composition to the substrate by directly contacting the substrate with the surface of the gravure plate, resulting in the transfer of the ink composition from the one or more cavities to the substrate.

19. The method of claim 15, wherein the step of transferring the ink composition comprises transferring the ink composition to a transfer surface, and contacting the substrate with the transfer surface resulting in a transfer of the ink composition to the substrate.

20. A metal nanowire structure comprising a structure formed by the method of claim 15.
